(19) United States
(12) Patent Application Publication
(10) Pub. No.: US 2026/0319530 A1
(43) Pub. Date: Oct. 15, 2026

(54) Information Processing Device and Set Pressure Calculating Method

(71) Applicant: Hitachi Industrial Equipment Systems Co., Ltd., Tokyo (JP)

(72) Inventors: Taito WATANABE, Tokyo (JP); Yohei KONO, Tokyo (JP); Yoshinori MOCHIZUKI, Tokyo (JP); Akira IYOZUMI, Tokyo (JP); Kenji KIMURA, Tokyo (JP); Yuki NAKAYAMA, Tokyo (JP)

(21) Appl. No.: 19/552,155

(22) Filed: Feb. 27, 2026

(30) Foreign Application Priority Data
Apr. 9, 2025 (JP) 2025-064565

(51) Int. Cl. G05D 16/20; G05B 13/02

(52) U.S. Cl. CPC G05D 16/20; G05B 13/0265

(57) ABSTRACT

An information processing device for calculating a set pressure of a fluid machine, the information processing device including: a learning model constructing section constructing a learning model that receives, as input, a supply pressure as a pressure of a fluid supplied from the fluid machine to a pipe at a first time, a terminal pressure as a pressure of the fluid at a terminal of the pipe, and a pressure loss feature amount, and outputs a terminal pressure at a second time at which a predetermined time has elapsed from the first time; a terminal state predicting section predicting a terminal pressure at a next time by inputting a supply pressure, a terminal pressure, and a pressure loss feature amount at a predetermined time to the learning model constructed by the learning model constructing section; a maximum pressure loss searching section searching for a maximum pressure loss as a maximum value of a pressure loss on the basis of a supply pressure, a terminal pressure, and a pressure loss feature amount at a time of operation of the fluid machine; an optimum supply pressure searching section searching for an optimum supply pressure that makes the terminal pressure a pressure equal to or higher than a necessary pressure at the terminal of the pipe, on the basis of the necessary pressure, the terminal state predicting section, and the maximum pressure loss searched for by the maximum pressure loss searching section; and a set pressure calculating section calculating the set pressure of the fluid machine on the basis of the optimum supply pressure searched for by the optimum supply pressure searching section and a set pressure at the time of operation of the fluid machine.

### BACKGROUND OF THE INVENTION

### 1. Field of the Invention

The present invention relates to a technology for calculating a set pressure of a fluid machine.

### 2. Description of the Related Art

Several proposals have conventionally been made with regard to the above-described technology.

JP-2009-13961-A, for example, describes a compressor apparatus including: a rotational speed control type compressor that is capacity-controlled such that a detected value of a compressed gas discharge pressure of the compressor coincides with a discharge pressure set target value set in advance, by controlling the motor rotational speed of the compressor on the basis of the detected value; a base load compressor that is capacity-controlled by repeating a load operation and a no-load operation; and a control device that controls each of the compressors, the control device having a computing section configured to automatically adjust the discharge pressure set target value of the compressor such that a terminal pressure in compressed gas operating equipment is constant irrespective of the magnitude of a pressure loss between a discharge port of the compressor and the compressed gas operating equipment.

According to the compressor apparatus described in JP-2009-13961-A, it is possible to provide a compressor apparatus and a control method thereof that prevent unnecessary power consumption with a stable operation without a response delay, by automatically adjusting the set target value of the discharge pressure according to the terminal pressure of the compressed gas operating equipment or the like.

### PRIOR ART DOCUMENT

### Patent Document

Patent Document 1: JP-2009-13961-A

### SUMMARY OF THE INVENTION

Efforts have been under way to reduce amounts of energy consumption in a manufacturing industry. In an ordinary factory, the power consumption of fluid machinery such as air compressors accounts for 20% to 30% of that of the factory as a whole, and thus energy saving operation of the fluid machinery has become one of challenges.

It is an object of the present invention to provide a technology for calculating the set pressure of a fluid machine that can ensure a pressure needed by a terminal apparatus (which pressure will hereinafter be referred to as a necessary pressure) even under conditions where the pressure of the terminal apparatus (which pressure will hereinafter be referred to as a terminal pressure) varies at a time of operation of the fluid machine.

According to claim 1 of the present invention, there is provided an information processing device for calculating a set pressure of a fluid machine, the information processing device including: a learning model constructing section constructing a learning model that receives, as input, a supply pressure as a pressure of a fluid supplied from the fluid machine to a pipe at a first time, a terminal pressure as a pressure of the fluid at a terminal of the pipe, and a pressure loss feature amount, and outputs a terminal pressure at a second time at which a predetermined time has elapsed from the first time; a terminal state predicting section predicting a terminal pressure at a next time, by inputting a supply pressure, a terminal pressure, and a pressure loss feature amount at a predetermined time to the learning model constructed by the learning model constructing section; a maximum pressure loss searching section searching for a maximum pressure loss as a maximum value of a pressure loss on the basis of a supply pressure, a terminal pressure, and a pressure loss feature amount at a time of operation of the fluid machine; an optimum supply pressure searching section searching for an optimum supply pressure that makes the terminal pressure a pressure equal to or higher than a necessary pressure at the terminal of the pipe, on the basis of the necessary pressure, the terminal state predicting section, and the maximum pressure loss searched for by the maximum pressure loss searching section; and a set pressure calculating section calculating the set pressure of the fluid machine on the basis of the optimum supply pressure searched for by the optimum supply pressure searching section and a set pressure at the time of operation of the fluid machine.

According to the present invention, the set pressure of the fluid machine that ensures the necessary pressure can be calculated even under conditions where the terminal pressure varies at the time of operation of the fluid machine. This can contribute to energy savings in a factory in which the fluid machine is used.

### BRIEF DESCRIPTION OF THE DRAWINGS

FIG. 1 is a schematic configuration diagram of a pneumatic system to which an information processing device according to a first embodiment of the present invention is applied;

FIG. 2 is a diagram of a hardware configuration of the information processing device according to the first embodiment of the present invention;

FIG. 3 is a functional block diagram of the information processing device according to the first embodiment of the present invention;

FIG. 4 is an example of data measured for learning model construction according to the first embodiment of the present invention;

FIG. 5 is a flowchart illustrating learning model construction processing according to the first embodiment of the present invention;

FIG. 6 is a diagram illustrating an example of a learning model according to the first embodiment of the present invention;

FIG. 7 is an example of a screen output at a time of the learning model construction according to the first embodiment of the present invention;

FIG. 8 is a flowchart illustrating set pressure calculation processing according to the first embodiment of the present invention;

FIG. 9 is a flowchart illustrating maximum pressure loss search processing according to the first embodiment of the present invention;

FIG. 10 is a flowchart illustrating optimum supply pressure search processing according to the first embodiment of the present invention;

FIG. 11 is a flowchart illustrating the set pressure calculation processing according to the first embodiment of the present invention;

FIG. 12 is an example of a screen output at a time of set pressure calculation according to the first embodiment of the present invention;

FIG. 13 is a schematic configuration diagram of a pneumatic system to which an information processing device according to a second embodiment of the present invention is applied;

FIG. 14 is an example of data measured for learning model construction according to the second embodiment of the present invention;

FIG. 15 is a flowchart illustrating learning model construction processing according to the second embodiment of the present invention; and

FIG. 16 is a flowchart illustrating maximum pressure loss search processing according to the second embodiment of the present invention.

### DESCRIPTION OF THE PREFERRED EMBODIMENTS

### First Embodiment

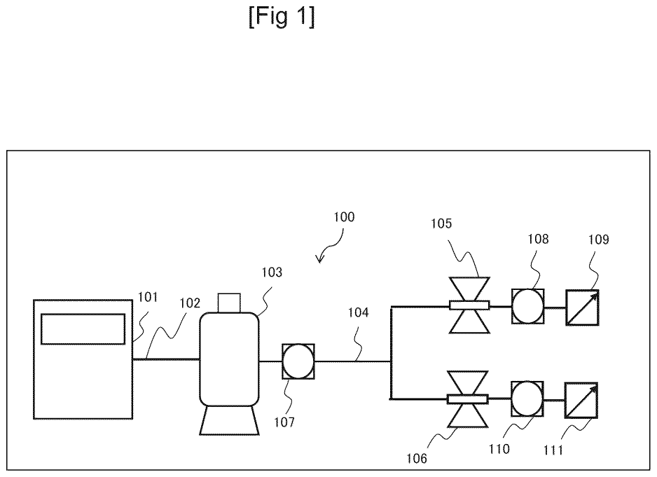

An information processing device according to a first embodiment of the present invention will be described with reference to FIGS. 1 to 12. Incidentally, in the present specification and the drawings, constituent elements having substantially identical functional configurations are given the same reference numerals, and thereby repeated description thereof will be omitted.

FIG. 1 illustrates a general configuration of a pneumatic system 100 that uses the information processing device according to the first embodiment. Incidentally, in the first embodiment, description will be made by taking an air compressor as an example of a fluid machine.

As illustrated in FIG. 1, the pneumatic system 100 according to the first embodiment includes an air compressor 101, an air tank 103, pipes 102 and 104, and terminal apparatuses 105 and 106. The air compressor 101 is connected to the air tank 103 via the pipe 102. The air tank 103 is connected to the terminal apparatuses 105 and 106 via the pipe 104. A pressure gage 107 is installed on the pipe 104. A pressure gage 108 and a flowmeter 109 are installed for the terminal apparatus 105. A pressure gage 110 and a flowmeter 111 are installed for the terminal apparatus 106.

A compressed air delivered from the air compressor 101 is stored in the air tank 103 via the pipe 102. The compressed air stored in the air tank 103 is transferred to the terminal apparatuses 105 and 106 via the pipe 104. The transferred compressed air is used by the terminal apparatuses 105 and 106.

The pressure of the compressed air delivered from the air compressor 101 is measured by the pressure gage 107. A supply pressure as the pressure of the compressed air supplied from the air compressor 101 to the pipe 104 is thereby obtained. The pressures of the compressed air used by the terminal apparatuses 105 and 106 are measured by the pressure gages 108 and 110. Terminal pressures at the terminal apparatuses 105 and 106 are thereby obtained.

The flow rates of the compressed air used by the terminal apparatuses 105 and 106 are measured by the flowmeters 109 and 111. The flow rates of the compressed air at the terminal apparatuses 105 and 106 (which flow rates will hereinafter be referred to as terminal flow rates) are thereby obtained.

Incidentally, while description is made assuming that there is one air compressor in the first embodiment, there may be a plurality of air compressors. In this case, compressed airs delivered from the plurality of air compressors are temporarily accumulated in the air tank via pipes. The pressure of the compressed airs accumulated in the air tank is measured as the supply pressure.

In addition, while description is made assuming that there are two terminal apparatuses in the first embodiment, there may be one or three or more terminal apparatuses.

Further, while a pressure gage and a flowmeter are installed for each terminal apparatus in the first embodiment, a pressure gage and a flowmeter may be installed for only a part of the plurality of terminal apparatuses. In a case where a pressure gage and a flowmeter are installed for only a part of the plurality of terminal apparatuses, a pressure gage and a flowmeter are preferably installed in order from a terminal apparatus at which a pressure is desired to be ensured. In addition, in a case where there is no terminal apparatus at which a pressure is desired to be ensured, a pressure gage and a flowmeter are preferably installed for a terminal apparatus located at a position most distant from the air compressor.

Furthermore, while the pipe 104 includes one branch and two elbows in the first embodiment, the configuration of the pipe is optional. The length and thickness of the pipe differ depending on a factory in which the pipe is applied. A loop pipe may be adopted.

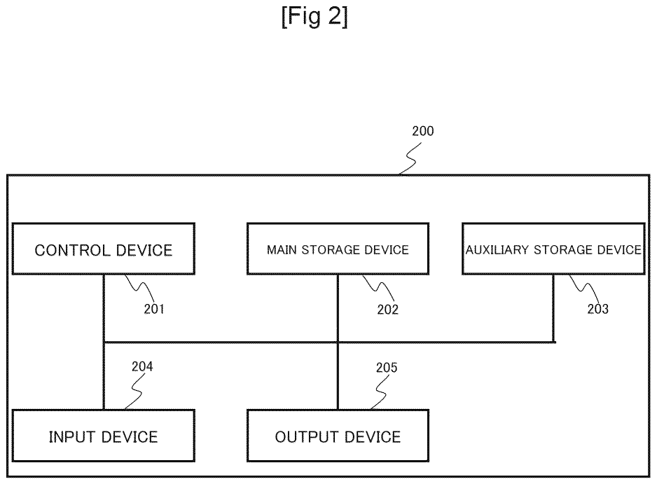

FIG. 2 illustrates a hardware configuration of an information processing device 200.

As illustrated in FIG. 2, the information processing device 200 includes a control device 201, a main storage device 202, an auxiliary storage device 203, an input device 204, and an output device 205.

The control device 201 is constituted by one or a plurality of arithmetic processing devices or a combination thereof. Cited as the arithmetic processing device(s) are, for example, a central processing unit (CPU), a micro processor unit (MPU), a graphics processing unit (GPU), a digital signal processor (DSP), and a field-programmable gate array (FPGA). The control device 201 performs arithmetic processing by reading a program stored in the auxiliary storage device 203 and cooperating with the main storage device 202.

The main storage device 202 is constituted by a temporary storage device or a combination thereof. Cited as the main storage device 202 are, for example, a static random access memory (SRAM), a dynamic random access memory (DRAM), a cache memory, and a flash memory. The main storage device 202 temporarily stores data necessary for the control device 201 to perform the arithmetic processing.

The auxiliary storage device 203 is constituted by a nonvolatile storage device or a combination thereof. Cited as the auxiliary storage device 203 are, for example, a hard disc drive (HDD) and a solid state drive (SSD). The auxiliary storage device 203 stores the program and data necessary for the control device 201 to perform the arithmetic processing.

The input device 204 is constituted by, for example, a keyboard, a pointing device, a touch panel, or a combination thereof. The input device 204 receives input of the supply pressure, the terminal pressures, and pressure loss feature amounts.

The output device 205 is constituted by, for example, a liquid crystal, a display such as an organic EL display, a touch panel, a projector, or a combination thereof. Predetermined information is displayed on the output device 205 through the arithmetic processing by the control device 201. The output device 205 outputs the terminal pressures estimated by a learning model and a terminal state predicting section 201b.

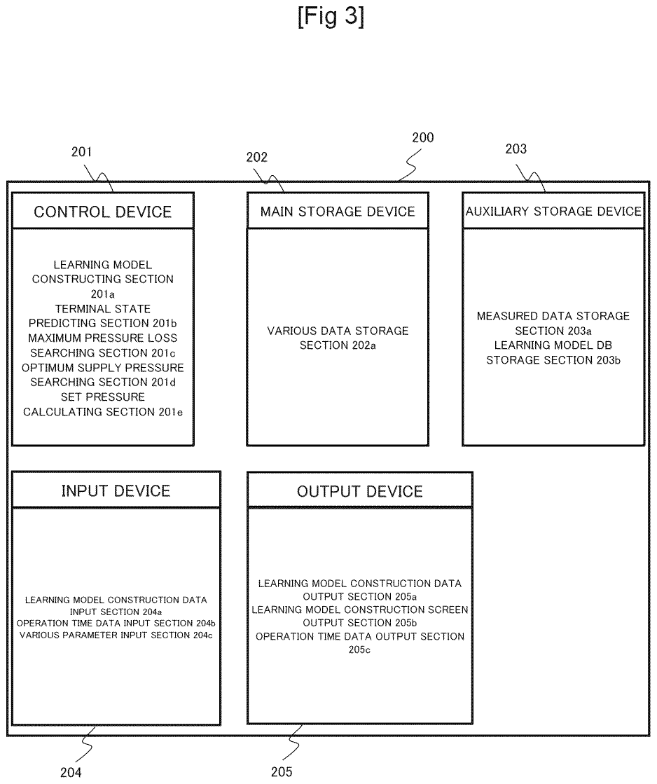

FIG. 3 illustrates functions of the information processing device 200. Each of the functions will be described in the following.

The control device 201 has a learning model constructing section 201a, a terminal state predicting section 201b, a maximum pressure loss searching section 201c, an optimum supply pressure searching section 201d, and a set pressure calculating section 201e.

The learning model constructing section 201a constructs a learning model that receives, as input, the supply pressure, the terminal pressures, and feature amounts of pressure losses (which feature amounts will hereinafter be referred to as pressure loss feature amounts) at a first time, and has, as output, the terminal pressures at a second time at which a predetermined time has elapsed from the first time. The construction of the learning model in the first embodiment uses the supply pressure measured by the pressure gage 107, the terminal pressures measured by the pressure gages 108 and 110, and the flow rates measured as the pressure loss feature amounts by the flowmeters 109 and 111. The constructed learning model is saved in a learning model storage section 203b of the auxiliary storage device 203 to be described later.

The terminal state predicting section 201b inputs the supply pressure, the terminal pressures, and the pressure loss feature amounts at a predetermined time to the learning model, and predicts the terminal pressures at a time (hereinafter referred to as a “next time”) at which a predetermined time has elapsed from the predetermined time. The prediction of the terminal state predicting section 201b in the first embodiment uses the supply pressure measured by the pressure gage 107, the terminal pressures measured by the pressure gages 108 and 110, and the flow rates measured by the flowmeters 109 and 111.

The maximum pressure loss searching section 201c searches for a maximum value of a pressure loss at a time of operation of the air compressor 101. In the first embodiment, this search uses the flow rates measured by the flowmeters 109 and 111.

The optimum supply pressure searching section 201d searches for a minimum supply pressure (hereinafter referred to as an optimum supply pressure) satisfying necessary pressures of the terminal apparatuses 105 and 106 on the basis of the necessary pressures, the maximum pressure loss searched for in the maximum pressure loss searching section 201c, and the terminal state predicting section 201b.

The set pressure calculating section 201e calculates a set pressure on the basis of the optimum supply pressure searched for in the optimum supply pressure searching section 201d and a set pressure at the time of operation of the air compressor 101.

The main storage device 202 has a various data storage section 202a. The various data storage section 202a temporarily stores data necessary for the control device 201 to perform various kinds of processing.

The auxiliary storage device 203 has a measured data storage section 203a and a learning model storage section 203b. The measured data storage section 203a saves the supply pressure measured by the pressure gage 107, the terminal pressures measured by the pressure gages 108 and 110, and the flow rates measured by the flowmeters 109 and 111. The learning model storage section 203b saves the learning model constructed by the learning model constructing section 201a.

The input device 204 has a learning model construction data input section 204a, an operation time data input section 204b, and a various parameter input section 204c.

The output device 205 has a learning model construction data output section 205a, a learning model construction screen output section 205b, and an operation time data output section 205c.

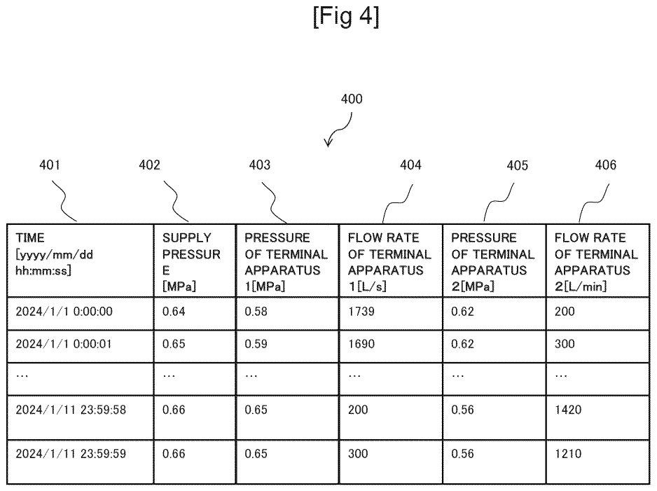

In the following, referring to FIGS. 4 to 12, a description will be made of a flow of calculating the set pressure of the air compressor 101 by using the information processing device 200 according to the first embodiment. The present flow includes learning model construction processing and set pressure calculation processing.

The learning model construction processing will be described with reference to FIGS. 4 to 7.

The learning model construction processing constructs the learning model to be used in the set pressure calculation processing. The pneumatic system 100 is expected to be constructed in a wide variety of factories. It is therefore necessary to grasp characteristics of the pneumatic system 100 in advance in constructing the learning model. As means for this grasping, data measurement of the pressures and the flow rates is performed by using the pressure gages 107, 108, and 110 and the flowmeters 109 and 111.

Data measurement work is performed by a user before the construction of the learning model. The user is, for example, a serviceperson of a manufacturer of the air compressor 101. The user inputs measured data by using the input device 204 in the information processing device 200. The input measured data is saved in the measured data storage section 203a of the auxiliary storage device 203.

FIG. 4 is an example of the data measured for the construction of the learning model.

The measured data 400 includes, for example, time, the supply pressure, the terminal pressures, and the terminal flow rates.

A column 401 indicates a measured time. A column 402 indicates the pressure measured by the pressure gage 107. A column 403 indicates the pressure measured by the pressure gage 108. A column 404 indicates the flow rate measured by the flowmeter 109. A column 405 indicates the pressure measured by the pressure gage 110. A column 406 indicates the flow rate measured by the flowmeter 111. The sampling time of the measurement is optional. However, the sampling time needs to be an interval that enables measurement of pressure variations due to changes in usage amount of the compressed air.

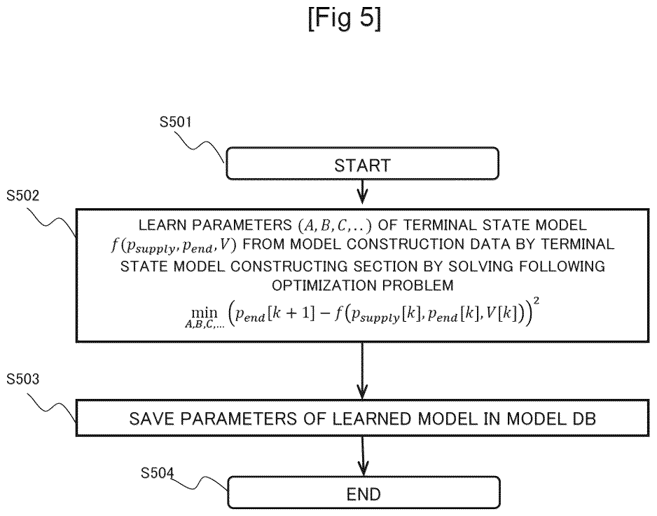

FIG. 5 illustrates the learning model construction processing.

The user performs the setting of learning model construction data, the setting of parameters of the learning model, and the setting of a data section, before the construction of the learning model.

The learning model construction data is data including the measured data illustrated in FIG. 4. The user sets, by using the input device 204, the data to be used for the construction of the learning model from the measured data saved in the measured data storage section 203a.

The data section represents a section to be used for the learning model in the measured data. The user sets, by using the input device 204, the data section and the parameters of the learning model.

The information of the learning model construction data, the parameters of the learning model, and the data section set by the user by using the input device 204 is saved in the main storage device 202 or the auxiliary storage device 203.

The control device 201 constructs the learning model after completion of the setting of the learning model construction data, the setting of the parameters of the learning model, and the setting of the data section by the user. In the following, a detailed description will be made with reference to FIG. 5.

After a start of the processing (S501), the learning model constructing section 201a of the control device 201 calls the information of the learning model construction data, the parameters of the learning model, and the data section saved in the main storage device 202 or the auxiliary storage device 203. In S502, the learning model constructing section 201a constructs the learning model (f(p_{supply}[k], p_{end}[k], V_{end}[k])). More specifically, the learning model is constructed by solving an optimization problem described in (S502) from the measured data in the set data section. Here, k denotes a time in the data. p_{supply}[k] denotes the supply pressure at time k. p_{end}[k] denotes the pressure of a terminal apparatus at time k. V_{end}[k] denotes the flow rate at the terminal apparatus.

The learning model constructed in S502 outputs the terminal pressure at a next time by being supplied with the actual measured values of the supply pressure, the terminal pressure, and the terminal flow rate.

The function f indicating the structure of the constructed learning model can be constructed by using a linear regression model, a neural net, or the like. However, the model constructed here needs to express such a response of pressure variation that the pressure of the terminal apparatus varies in response to an increase in the flow rate. In addition, the model needs to have such a characteristic that the terminal pressure converges to a predetermined value (does not diverge) even when fixed values are input as the supply pressure, the terminal pressure, and the terminal flow rate to the learning model, and the terminal pressure in the future continues to be estimated. This characteristic of the model is realized by determining the parameters of the model such that the absolute value of an eigenvalue of the model is less than 1 in a case of a linear regression model.

The parameters of the learning model constructed in S502 are saved in the main storage device 202 or the learning model storage section 203b of the auxiliary storage device 203 (S503). Incidentally, the model itself may be saved.

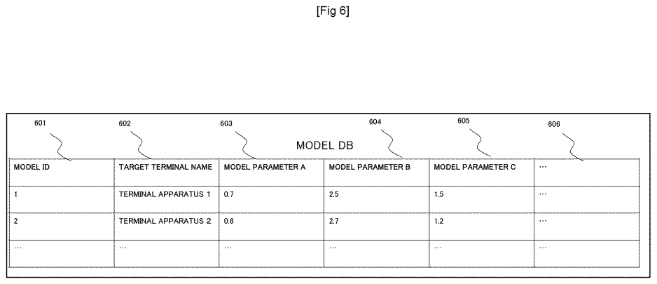

FIG. 6 illustrates an example of the saved learning model. A column 601 indicates a model ID for identifying the model. A column 602 indicates the name of the terminal apparatus targeted by the model. Columns 603 to 606 indicate the parameters of the model calculated by the learning model constructing section 201a.

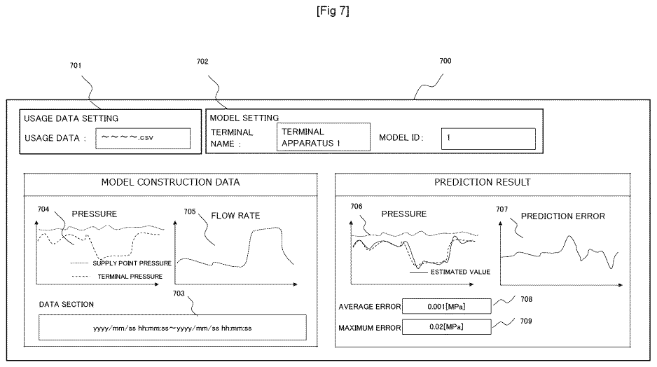

Here, the designation of the model construction data, the setting of the parameters of the model, and the setting of the data section by the user will be described in detail with reference to FIG. 7. FIG. 7 illustrates an example of a screen output on the output device 205 at a time of the construction of the learning model.

The learning model construction data is set in an area 701.

The user sets, in an area 702, for which terminal apparatus among the plurality of terminal apparatuses to construct the learning model. In addition, the user also sets the ID of the constructed learning model in the area 702.

The data section is set in an area 703.

A graph 704 illustrates the data of the supply pressure and the terminal pressure in the data section set in the area 703 in the data set in the area 701.

A graph 705 illustrates the data of the terminal flow rate in the data section designated in the area 703 in the data set in the area 701.

A graph 706 illustrates the graph 704 and an estimated value of the terminal pressure. The estimated value of the terminal pressure is calculated on the basis of the learning model construction data and the terminal state predicting section 201b.

A graph 707 indicates an error between the data of the terminal pressure and the estimated value of the terminal pressure that are illustrated in the graph 706.

An axis of abscissas of each of the graphs 704, 705, 706, and 707 indicates time. An axis of ordinates in the graphs 704, 706, and 707 indicates a pressure value. An axis of ordinates in the graph 705 indicates a flow rate value.

An area 708 indicates an average value of the prediction error illustrated in the graph 707. An area 709 indicates a maximum value of the prediction error illustrated in the graph 707.

The user checks the graphs 706 and 707 and the areas 708 and 709, and thereby checks a degree of error to which the constructed learning model can be constructed. When the values displayed in the areas 708 and 709 are larger than predicted values of the user, whether there is noise in the data set in the area 701 is checked. When there is noise, the data section including the noise is excluded in the area 703.

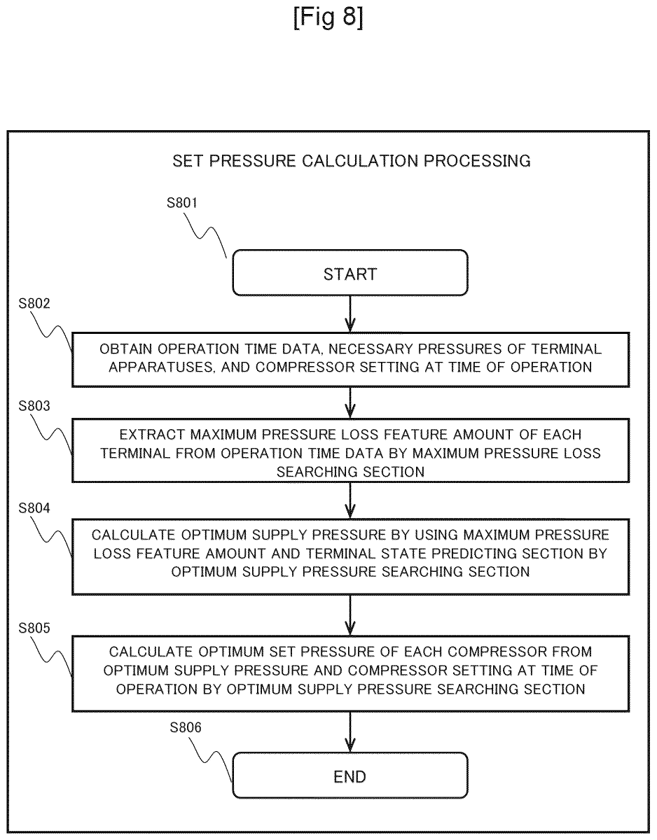

The set pressure calculation processing will next be described with reference to FIGS. 8 to 12.

FIG. 8 illustrates the set pressure calculation processing.

The user inputs operation time data, necessary pressures, and a set pressure as a set value of the air compressor at the time of operation, before set pressure calculation.

The operation time data is data measured by each measuring instrument at the time of operation of the air compressor 101. The operation time data is data similar to the measured data for the construction of the learning model which data is illustrated in FIG. 4. However, unlike the data measured for the construction of the learning model, characteristics of the air compressor at the time of operation need to be measured. The operation time data is therefore preferably data measured at least over one week. Incidentally, the data section is also set at a time of input of the operation time data.

The necessary pressures are specified pressures of the terminal apparatuses 105 and 106 being used. Incidentally, the number N of terminal apparatuses is input additionally at a time of input of the necessary pressures.

The set value of the air compressor 101 at the time of operation is the set pressure of the air compressor 101 at a time of obtainment of the operation time data.

These pieces of processing by the user are performed by using the input device 204 in the information processing device 200. The operation time data, the necessary pressures, and the set pressure of the air compressor at the time of operation that are input by the user by using the input device 204 are saved in the main storage device 202 or the auxiliary storage device 203.

After completion of the input of the operation time data, the input of the necessary pressures, and the input of the set pressure of the air compressor at the time of operation that are performed by the user, that is, after completion of these pieces of processing, the control device 201 calculates a set pressure. In the following, the set pressure calculation processing will be described in detail with reference to FIGS. 8 to 11.

After a start of the processing (S801), in S802, the control device 201 calls and obtains the operation time data, the necessary pressures, and the set pressure of the air compressor at the time of operation that are saved in the main storage device 202 or the auxiliary storage device 203.

In S803, the maximum pressure loss searching section 201c of the control device 201 searches for the maximum pressure losses of the terminal apparatuses 105 and 106 from the operation time data, and extracts maximum pressure loss feature amounts.

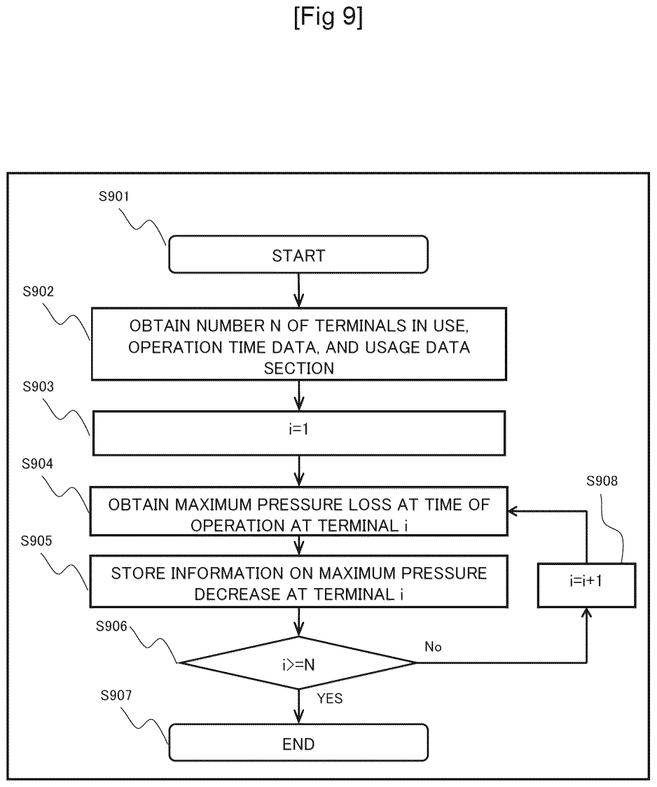

Here, step S803 will be described in detail with reference to FIG. 9.

FIG. 9 illustrates maximum pressure loss search processing.

After a start of the processing (S901), in S902, the maximum pressure loss searching section 201c of the control device 201 obtains the number N of terminal apparatuses, the operation time data, and the usage data section that are saved in the main storage device 202 or the auxiliary storage device 203.

The number N of terminal apparatuses is the number of terminal apparatuses for which a pressure gage and a flowmeter are installed. In the first embodiment, N=2. The number N of terminal apparatuses is set at the time of input of the necessary pressures of the terminal apparatuses.

The usage data section is set at the time of input of the operation time data, and is used for the maximum pressure loss search processing.

In S903, one terminal apparatus as a target among the number N of terminal apparatuses is designated.

In S904, a maximum pressure loss feature amount at the time of operation is obtained by using the operation time data of the one terminal apparatus in the usage data section. Here, the maximum pressure loss feature amount in the first embodiment is a maximum value of the flow rate measured by the flowmeter installed for the terminal apparatus.

Here, an estimated flow rate obtained by inputting the supply pressure and the terminal pressure to the learning model constructed in the learning model construction processing may be used as the maximum pressure loss feature amount.

The estimated flow rate can be used in a case where the function f indicating the structure of the constructed learning model is a linear regression model, a neural network, or the like. The use of the estimated flow rate makes it possible to calculate a set pressure including the errors of the learning model.

In S905, the obtained maximum pressure loss feature amount is stored. The stored maximum pressure loss feature amount is saved in the main storage device 202 or the auxiliary storage device 203. The processing of S904 and S905 is repeatedly performed a number of times corresponding to the number of terminal apparatuses obtained in S902 (S906 and S908).

Returning to FIG. 8, in S804, the optimum supply pressure searching section 201d calculates an optimum supply pressure by using the maximum pressure loss feature amount searched for in S803 and the terminal state predicting section 201b.

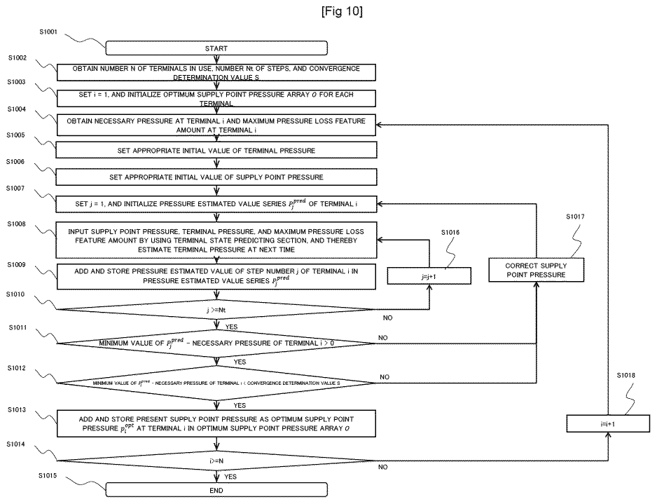

Here, step S804 will be described in detail with reference to FIG. 10.

FIG. 10 illustrates optimum supply pressure search processing.

After a start of the processing (S1001), in S1002, the optimum supply pressure searching section 201d of the control device 201 obtains the number N of terminal apparatuses, a number Nt of steps, and a convergence determination value S that are saved in the main storage device 202 or the auxiliary storage device 203. The number Nt of steps and the convergence determination value S are input additionally at the time of input of the set pressure of the air compressor at the time of operation.

In S1003, an array of the optimum supply pressure of each terminal apparatus is initialized.

In S1004, the necessary pressure and the maximum pressure loss feature amount obtained in S803 are obtained.

In S1005 and S1006, the optimum supply pressure searching section 201d sets appropriate initial values of the terminal pressure and the supply pressure.

In S1007, an array Pⱼ^{pred} for saving a pressure estimated value of the learning model is initialized.

In S1008, the optimum supply pressure searching section 201d inputs the supply pressure, the terminal pressure, and the maximum pressure loss feature amount to the learning model by using the terminal state predicting section 201b. A terminal pressure at a next time is thereby estimated.

In S1009, the estimated terminal pressure is added to and stored in the pressure estimated value array Pⱼ^{pred}. The terminal pressure estimated and added to the pressure estimated value array Pⱼ^{pred} is saved in the main storage device 202 or the auxiliary storage device 203.

The processing of S1008 and S1009 is repeatedly performed a number of times corresponding to the number Nt of steps set in S1002 (S1010 and S1016).

When steps S1010 and S1016 are ended, a determination of S1011 is performed. In S1011, whether or not a minimum value of estimated terminal pressures stored in the pressure estimated value array is larger than the necessary pressure of the terminal apparatus (whether or not a value obtained by subtracting the necessary pressure of the terminal apparatus from the minimum value of the estimated terminal pressures is larger than 0) is determined. When the minimum value of the estimated terminal pressures is smaller than the necessary pressure, the optimum supply pressure searching section 201d corrects the set supply pressure, and performs the processing from S1007 to S1010. When the minimum value of the estimated terminal pressures is larger than the necessary pressure, on the other hand, whether or not a difference between the minimum value of the estimated terminal pressures and the necessary pressure of the terminal apparatus is larger than the convergence determination value is determined (S1012).

When the difference between the minimum value of the estimated terminal pressures and the necessary pressure of the terminal apparatus is larger than the convergence determination value in S1012, the optimum supply pressure searching section 201d corrects the set supply pressure, and performs the processing from S1007 to S1010. When the difference between the minimum value of the estimated terminal pressures and the necessary pressure of the terminal apparatus is smaller than the convergence determination value, the supply pressure set at this time point is added to and stored in the optimum supply pressure array O (S1013).

Steps S1004 to S1013 are repeatedly performed a number of times corresponding to the number N of terminal apparatuses. The optimum supply pressure is thereby calculated for each target terminal apparatus.

Returning to FIG. 8, in S805, the set pressure calculating section 201e calculates a set pressure by using the optimum supply pressure calculated in S804.

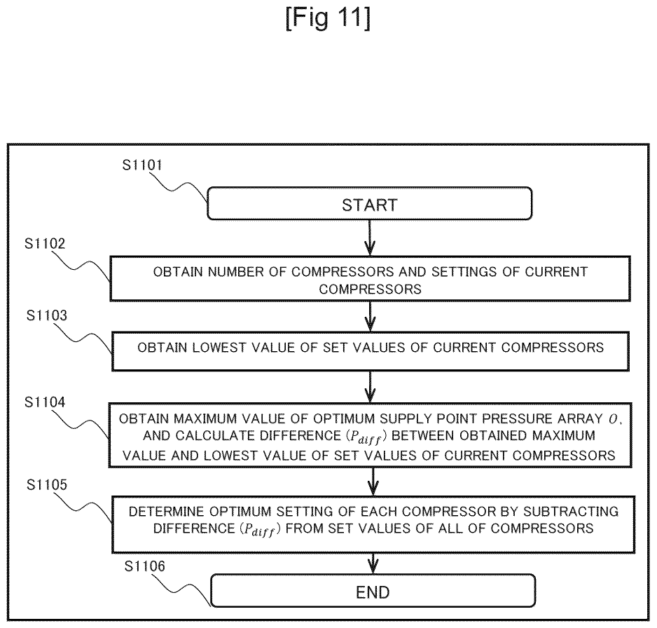

Here, step S805 will be described in detail with reference to FIG. 11.

FIG. 11 illustrates the set pressure calculation processing.

In S1102, the set pressure calculating section 201e of the control device 201 obtains the number of current air compressors and set pressures that are saved in the main storage device 202 or the auxiliary storage device 203. The number of current air compressors is input additionally at the time of input of the set pressure of the air compressor at the time of operation.

In S1103, a minimum value of the obtained set pressures is obtained.

In S1104, a maximum value is obtained from the optimum supply pressure array calculated in step S804. A difference p_{diff} between the obtained maximum value and the lowest value of the current set pressures is calculated.

In S1105, the value of the difference p_{diff} is subtracted from the set pressure of each current air compressor. An optimum pressure of each air compressor is thereby calculated.

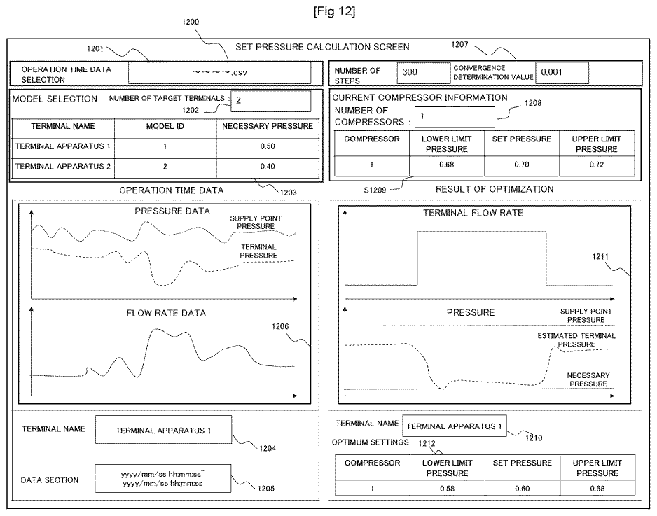

FIG. 12 is an example of a screen 1200 output at a time of the set pressure calculation.

The setting of the operation time data to be used at the time of the set pressure calculation is made in an area 1201.

The input of the number of terminal apparatuses for which a pressure gage and a flowmeter are installed is performed in an area 1202.

The input of the necessary pressures of the terminal apparatuses to be set as a target is performed in an area 1203.

The setting of a terminal apparatus to be set as a target is made in an area 1204 and an area 1210.

The setting of a data section to be used for the set pressure calculation in the operation time data set in the area 1201 is made in an area 1205.

A graph 1206 indicates the supply pressure, the terminal pressure, and the flow rate in the data section set in the area 1205 with regard to the terminal apparatus set in the area 1204.

The setting of the number Nt of steps and the convergence determination value S is made in an area 1207.

The input of the number of air compressors is performed in an area 1208.

The input of the set pressure of the air compressor is performed in an area 1209. The “set pressure” referred to here includes a lower limit pressure and an upper limit pressure in addition to the set pressure. The “lower limit pressure” is a pressure serving as an index for starting another compressor when falling below a threshold value. The “upper limit pressure” is a pressure serving as an index for stopping the compressor when exceeding a threshold value.

A graph 1211 indicates the following four: first, the maximum pressure loss feature amount of the terminal apparatus set in the area 1210; second, the optimum supply pressure searched for by the optimum supply pressure searching section 201d; third, the estimated terminal pressure; and fourth, the necessary pressure input in the area 1203.

Optimum settings of the air compressor calculated by the set pressure calculating section 201e are displayed in an area 1212. In addition, the optimum settings of the air compressor calculated by the set pressure calculating section 201e are saved in the main storage device 202 or the auxiliary storage device 203.

The optimum setting display area 1212 is an area for displaying the optimum settings of the current air compressor calculated by the set pressure calculating section 201e. Incidentally, while the number N of terminal apparatuses is set at N=2 and the number of compressors is set as 1 in the first embodiment, the respective numbers are optional.

As described above, according to the first embodiment, the learning model is constructed which estimates the terminal pressure in the future from the measured values of the supply pressure, the terminal pressure, and the flow rate. An optimum set pressure of the air compressor can be calculated from the constructed learning model and the measured values of the supply pressure, the terminal pressure, and the flow rate during operation.

### Second Embodiment

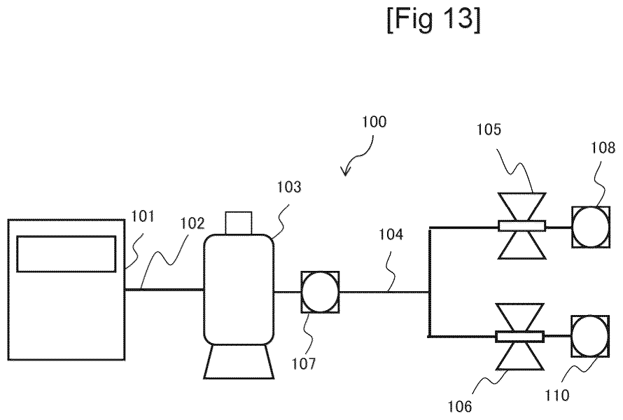

An information processing device 200 according to a second embodiment of the present invention will be described with reference to FIGS. 13 to 16. Incidentally, in the second embodiment, description will be made by taking an air compressor as an example of a fluid machine.

The information processing device 200 according to the first embodiment uses the flow rate as the maximum pressure loss feature amount. However, the flowmeter that measures the flow rate is expensive as compared with the pressure gage. It is therefore preferable to be able to calculate the set pressure by using only the pressure gage. Accordingly, a case will be described in which the information processing device 200 according to the second embodiment does not use the terminal flow rate as measured data in the learning model construction processing and the set pressure calculation processing.

FIG. 13 illustrates a general configuration of a pneumatic system 100 that uses the information processing device 200 according to the second embodiment. Unlike FIG. 1, no flowmeters are installed.

In addition, a hardware configuration and functions of the information processing device 200 are similar to those illustrated in FIG. 2 and FIG. 3.

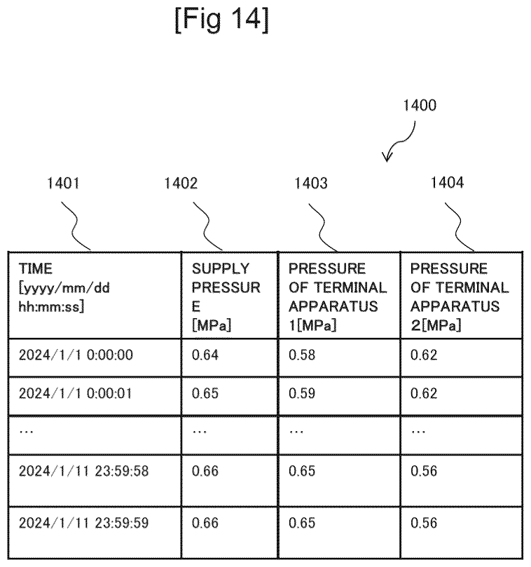

In the following, referring to FIGS. 14 to 16, a description will be made of a flow of calculating the set pressure of the air compressor 101 by using the information processing device 200 according to the second embodiment.

The learning model construction processing will be described with reference to FIGS. 14 to 16.

In the second embodiment, the pressure gages 107, 108, and 110 are used to measure the supply pressure and the terminal pressures.

FIG. 14 is an example of the data measured for the construction of the learning model.

The measured data 1400 includes for example, a time (column 1401), the supply pressure (column 1402), and the terminal pressures (columns 1403 and 1404).

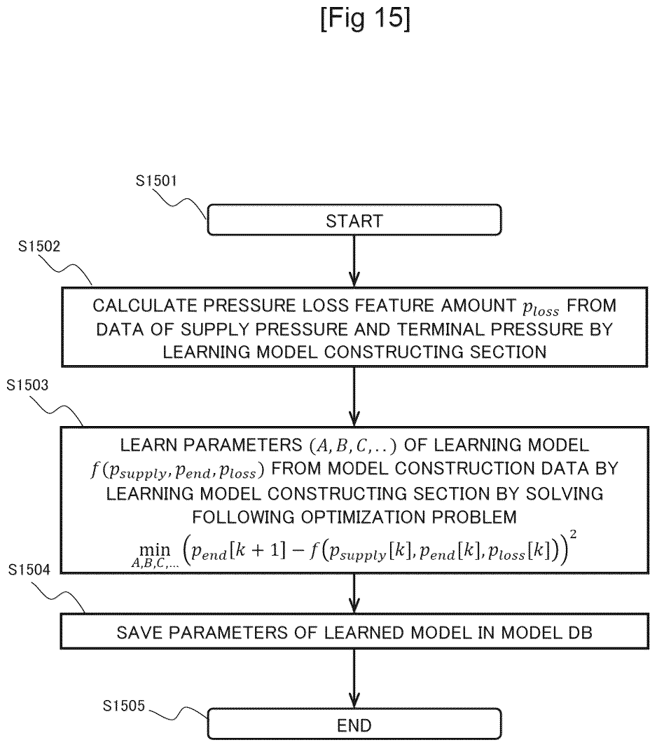

FIG. 15 illustrates the learning model construction processing.

The user performs the setting of model construction data, the setting of model parameters, and the setting of a data section, before the construction of the learning model.

The model construction data is data including the measured data illustrated in FIG. 14.

The data section represents a section to be used for the learning model in the measured data.

These pieces of processing by the user are performed by using the input device 204 in the information processing device 200.

The control device 201 constructs the learning model after completion of these pieces of processing. In the following, a detailed description will be made with reference to FIG. 15.

In S1502, the learning model constructing section 201a calculates a pressure loss feature amount on the basis of the supply pressure and the terminal pressure. Here, the pressure loss feature amount is a calculated value of a differential pressure between the supply pressure and the terminal pressure at each time. Incidentally, the pressure loss feature amount may be simply a value obtained by subtracting the terminal pressure from the supply pressure. In addition, a feature amount that expresses a pressure difference at a next time may be calculated by using information such as an amount of change from a previous time and the value obtained by subtracting the terminal pressure from the supply pressure. The pressure difference at the next time can be expressed by, for example, adding a change speed between a present pressure difference and a pressure difference at a previous time to the present pressure difference.

In S1503, the learning model constructing section 201a constructs the learning model. More specifically, the learning model is constructed by solving an optimization problem described in (S1503) from the measured data in the set data section. Here, k denotes a time in the data. p_{supply}[k] denotes the supply pressure at time k. p_{end}[k] denotes the pressure of the terminal apparatus at time k.

The learning model constructed in S1503 outputs the terminal pressure at a next time by being supplied with the actual measured values of the supply pressure, the terminal pressure, and the pressure loss feature amount.

The function f indicating the structure of the constructed learning model can be constructed by using a linear regression model, a neural net, or the like. However, the model constructed here needs to express such a response of pressure variation that the pressure of the terminal apparatus varies in response to an increase in the flow rate. In addition, the model needs to have such a characteristic that the terminal pressure converges to a predetermined value (does not diverge) even when fixed values are input as the supply pressure, the terminal pressure, and the terminal flow rate to the learning model, and the terminal pressure in the future continues to be estimated. This characteristic of the model is realized by determining the parameters of the model such that the absolute value of an eigenvalue of the model is less than 1 in a case of a linear regression model.

The learning model constructed in S1503 is saved in the learning model storage section 203b of the auxiliary storage device 203 (S1504).

The learning model saved in S1504 is saved in a format similar to that of FIG. 6.

The designation of the model construction data, the setting of the parameters of the model, and the setting of the data section by the user are performed in a format similar to that of FIG. 7.

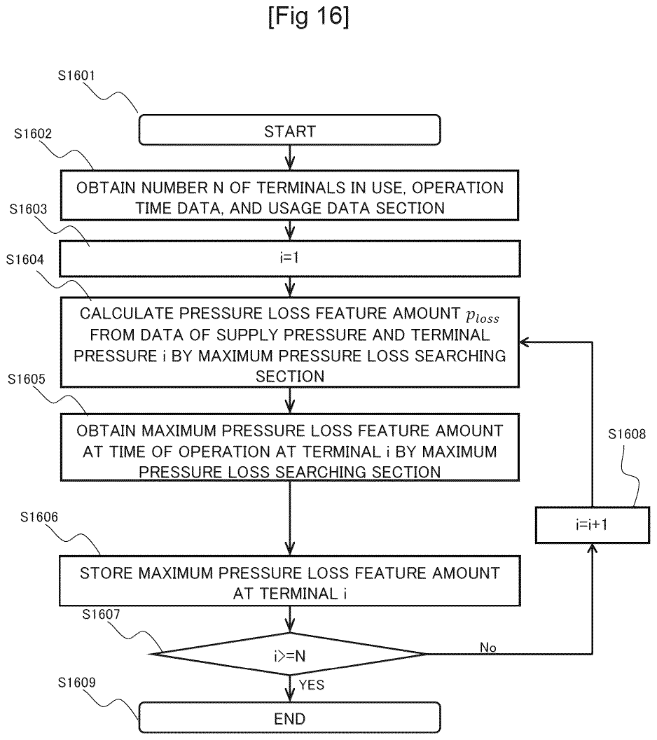

The set pressure calculation processing will next be described with reference to FIG. 16.

The set pressure calculation processing is, except for a part thereof, the same as the set pressure calculation processing illustrated in FIG. 8 according to the first embodiment.

In the following, differences from the set pressure calculation processing according to the first embodiment will be described.

FIG. 16 illustrates maximum pressure loss search processing.

In S1602, the maximum pressure loss searching section 201c obtains the number N of terminal apparatuses, the operation time data, and the usage data section.

In S1603, one terminal apparatus as a target among the number N of terminal apparatuses is designated. In S1604, the maximum pressure loss searching section 201c calculates a pressure loss feature amount pₗₒₛₛ as a calculated value of the differential pressure between the supply pressure and the terminal pressure.

In S1605, the maximum pressure loss searching section 201c obtains a maximum pressure loss feature amount at the time of operation by using the operation time data of the one terminal apparatus in the usage data section. Here, the maximum pressure loss feature amount in the second embodiment is a maximum value of the pressure loss feature amount calculated in S1604.

Here, an estimated value obtained by substituting the supply pressure and the terminal pressure into the learning model may be used as the maximum pressure loss feature amount.

The estimated value can be used in a case where the function f indicating the structure of the constructed learning model is a linear regression model, a neural network, or the like. The use of the estimated value makes it possible to calculate a set pressure including the errors of the learning model.

In S1606, the obtained maximum pressure loss feature amount is stored. The processing of S1604 to S1606 is repeatedly performed a number of times corresponding to the number of terminal apparatuses obtained in S1602 (S1607 and S1608).

The optimum supply pressure searching section 201d calculates an optimum supply pressure by using the maximum pressure loss feature amount searched for in S1601 to S1609 and the terminal state predicting section 201b. The optimum supply pressure search processing and the set pressure calculation processing are the same as in FIG. 10 and FIG. 11 according to the first embodiment.

As described above, according to the second embodiment, the learning model is constructed which estimates the terminal pressure in the future from the measured values of the supply pressure and the terminal pressure. An optimum set pressure of the air compressor can be calculated from the constructed learning model and the measured values of the supply pressure and the terminal pressure during operation.

In the first and second embodiments, description has been made by taking an air compressor as an example of a fluid machine. However, the present invention is not limited to these embodiments. The present invention is applicable also in cases where another fluid is handled in a pump or the like. In addition, various changes can be made without departing from the spirit of the present invention.

### DESCRIPTION OF REFERENCE NUMERALS

100: pneumatic system
101: air compressor
102, 104: pipe
103: air tank
105, 106: terminal apparatus
107, 108, 110: pressure gage
109, 111: flowmeter
200: information processing device
201: control device
201a: learning model constructing section
201b: terminal state predicting section
201c: maximum pressure loss searching section
201d: optimum supply pressure searching section
201e: set pressure calculating section
202: main storage device
203: auxiliary storage device
203a: measured data storage section
203b: learning model storage section
204: input device
204a: learning model construction data input section
204b: operation time data input section
204c: various parameter input section
205: output device
205a: learning model construction data output section
205b: learning model construction screen output section
205c: operation time data output section
400: measured data
401, 402, 403, 404, 405, 406: column
601, 602, 603, 604, 605, 606: column
701, 702, 703, 708, 709: area
704, 705, 706, 707: graph
1200: screen
1201, 1202, 1203, 1204, 1205, 1207, 1208, 1209, 1210: area
1206, 1211: graph
1212: optimum setting display area
1401, 1402, 1403, 1404: column

What is claimed is:

1. An information processing device for calculating a set pressure of a fluid machine, the information processing device comprising:
a learning model constructing section constructing a learning model that receives, as input, a supply pressure as a pressure of a fluid supplied from the fluid machine to a pipe at a first time, a terminal pressure as a pressure of the fluid at a terminal of the pipe, and a pressure loss feature amount, and outputs a terminal pressure at a second time at which a predetermined time has elapsed from the first time;
a terminal state predicting section predicting a terminal pressure at a next time by inputting a supply pressure, a terminal pressure, and a pressure loss feature amount at a predetermined time to the learning model constructed by the learning model constructing section;
a maximum pressure loss searching section searching for a maximum pressure loss as a maximum value of a pressure loss on a basis of a supply pressure, a terminal pressure, and a pressure loss feature amount at a time of operation of the fluid machine;
an optimum supply pressure searching section searching for an optimum supply pressure that makes the terminal pressure a pressure equal to or higher than a necessary pressure at the terminal of the pipe, on a basis of the necessary pressure, the terminal state predicting section, and the maximum pressure loss searched for by the maximum pressure loss searching section; and
a set pressure calculating section calculating the set pressure of the fluid machine on a basis of the optimum supply pressure searched for by the optimum supply pressure searching section and a set pressure at the time of operation of the fluid machine.

2. The information processing device according to claim 1, wherein
the pressure loss feature amount is a terminal flow rate as a flow rate of the fluid at the terminal of the pipe or a calculated value of a differential pressure between the supply pressure and the terminal pressure.

3. The information processing device according to claim 1, further comprising:
an input device; and an output device, wherein
the input device
receives the input of the supply pressure, the terminal pressures, and the pressure loss feature amount, and
the output device
outputs the learning model constructed by the learning model constructing section and a predicted terminal pressure predicted in the terminal state predicting section.

4. The information processing device according to claim 1, further comprising: an input device; and an output device, wherein
the input device
receives input of the necessary pressure at the terminal of the pipe, and
the output device
outputs the optimum supply pressure searched for by the optimum supply pressure searching section.

5. The information processing device according to claim 1, further comprising: an input device; and an output device, wherein
the input device
receives input of the set pressure at the time of operation of the fluid machine, and
the output device
outputs the set pressure of the fluid machine calculated by the set pressure calculating section.

6. A set pressure calculating method for calculating a set pressure of a fluid machine, the set pressure calculating method comprising:
a learning model constructing step of constructing a learning model that receives, as input, a supply pressure as a pressure of a fluid supplied from the fluid machine to a pipe at a first time, a terminal pressure as a pressure of the fluid at a terminal of the pipe, and a pressure loss feature amount, and outputs a terminal pressure at a second time at which a predetermined time has elapsed from the first time;
a terminal state predicting step of predicting a terminal pressure at a next time by inputting a supply pressure, a terminal pressure, and a pressure loss feature amount at a predetermined time to the learning model constructed in the learning model constructing step;
a maximum pressure loss searching step of searching for a maximum pressure loss as a maximum value of a pressure loss on a basis of a supply pressure, a terminal pressure, and a pressure loss feature amount at a time of operation of the fluid machine;
an optimum supply pressure searching step of searching for an optimum supply pressure that makes the terminal pressure a pressure equal to or higher than a necessary pressure at the terminal of the pipe on a basis of a necessary pressure at the terminal of the pipe, the terminal state predicting step, and the maximum pressure loss searched for in the maximum pressure loss searching step; and
a set pressure calculating step of calculating the set pressure of the fluid machine on a basis of the optimum supply pressure searched for in the optimum supply pressure searching step and a set pressure at the time of operation of the fluid machine.

7. The set pressure calculating method according to claim 6, wherein
the pressure loss feature amount is a terminal flow rate as a flow rate of the fluid at the terminal of the pipe or a calculated value of a differential pressure between the supply pressure and the terminal pressure.

8. The set pressure calculating method according to claim 6, comprising:
a step of receiving the input of the supply pressure, the terminal pressures, and the pressure loss feature amount; and
a step of outputting the learning model constructed in the learning model constructing step and the predicted terminal pressure predicted based on the terminal state predicting step.

9. The set pressure calculating method according to claim 6, comprising:
a step of receiving input of the necessary pressure at the terminal of the pipe; and
a step of outputting the optimum supply pressure searched for in the optimum supply pressure searching step.

10. The set pressure calculating method according to claim 6, comprising:
a step of receiving input of the set pressure at the time of operation of the fluid machine; and
a step of outputting the set pressure of the fluid machine calculated in the set pressure calculating step.
